(19) United States
(12) Patent Application Publication
(10) Pub. No.: US 2004/0009267 A1
(43) Pub. Date: Jan. 15, 2004

(54) Frozen fruit filled pie production

(76) Inventors: Samuel Clayton Muggride, Lawrenceville, GA (US); William Michael Hesler, St. Petersburg, FL (US)

Correspondence Address: DORSEY & WHITNEY LLP, Intellectual Property Department, Suite 1500, 50 South Sixth Steeet, Minneapolis, MN, 55402-1498, US

(21) Appl. No.: 10/617,691

(22) Filed: Jul. 14, 2003

Related U.S. Application Data
(60) Provisional application No. 60/396,429, filed on Jul. 15, 2002.

(51) Int. Cl. A23G 3/00

(52) U.S. Cl. 426/95; 426/556

(57) ABSTRACT

In a method for manufacturing a frozen fruit filled pie, ingredients are mixed to create pie dough and formed into pie shells. Individually quickly frozen (“IQF”) fruit is added to the pie shell and a suspension is deposited over the IQF fruit in the pie shells. The pie is then sealed and frozen, thereby allowing the IQF fruit to remain frozen throughout the manufacturing process. Upon baking, the suspension suspends all of the pie ingredients and IQF fruit in a uniform fashion in a glossy smooth fruit pie filling.

### CROSS-REFERENCE TO RELATED APPLICATION

The priority of the Jul. 15, 2002 filing date of U.S. Provisional Application Serial No. 60/396,429 is hereby claimed.

### BACKGROUND

Frozen fruit pies are currently produced using one of three methods. In the first method, ingredients are mixed to create pie dough. The pie dough is then mechanically formed into pie shells in pie pans. The pie shells are then conveyed to a point on the production line where individually quickly frozen (“IQF”) fruit is mechanically added into the pie shell. The shells with the IQF fruit are then conveyed to a point on the production line where a mixture of dry ingredients is added on top of the IQF fruit. The shells with fruit and dry ingredients are then conveyed to a point in the line where a mechanically formed sheet of dough is applied to the top of the pie. This top sheet of dough is then mechanically sealed to the bottom dough. The constructed pie is then conveyed through a freezer and to packaging stations. Finally, the frozen pie is packaged and moved to frozen storage for distribution

In a second method, ingredients are mixed to create pie dough. The pie dough is then mechanically formed into pie shells in pie pans. The shells are conveyed to a point on the production line where a mixture of IQF fruit, liquid and dry sweeteners, minor ingredients, flavors and stabilizers is added by hand into the pie shells. The fruit mixture is made by adding fruit to a mechanical mixer. Then a liquid sweetener (e.g., high fructose corn syrup) is sprayed onto the fruit. Next dry ingredients, including sugar or other sweetener, starch, food gums, salt, flavors and minor ingredients are added to the mixer. The fruit coated with liquid sweetener is tumbled and mixed with the dry ingredients, which results in a relatively uniform coating of the fruit. Workers then measure the proper amount of fruit mixture into stainless steel bowls. Digital scales are used to control the weight of fruit mixture placed in each bowl. The bowls are then handed to workers who are stationed on the production line to “shape” the fruit and to ensure that the proper distribution of the filling occurs. The filled pie shells are conveyed to a point in the line where a mechanically formed sheet of dough is applied to the top of the pie. This top sheet of dough is mechanically sealed to the bottom dough. The constructed pie is conveyed through a freezer and then to packaging stations. Finally, the frozen pie is packaged and moved to frozen storage for distribution.

In a third known method of production, the fruit is cooked (whether IQF or not) with a combination of ingredients which imparts the appropriate characteristics to the finished product. Cooked pie fillings are sometimes referred to as slurry fillings. Cooking fruit prior to adding it to a pie shell produces a number of characteristics in the fruit including softening of fruit, damage to fruit during pumping and filling of the pie, loss or dulling of fresh fruit color, loss in fruit volume and marked changes in flavor. Additionally, when a filling such a slurry fruit filling is deposited into a shell a certain amount of “leveling” occurs which creates a flat top crust when the pie is baked. In contrast, when an IQF pie, such as that described in the first and second methods above, is filled, the frozen fruit pieces remain mounded. The top crust exhibits the contours of the fruit pieces, both during and after the bake process. This appearance is consistent with a homemade pie, and importantly, this appearance denotes quality.

Quality pies can be produced using the three methods described above, however, each of the known prior art methods described above have various shortcomings. For example, the first method requires a very expensive starch. In addition, the process of applying the dry ingredients to the fruit can produce a process bottleneck in the manufacturing line. Due to the nature of handling (weighing and depositing) dry materials with unique flow properties, substantial capital investment is required in order to significantly speed up this first existing method. The second method described above is labor intensive and slow. Additionally, the time required to facilitate the mixing process and the mixing itself create a strong potential for the fruit to thaw before the filled pies can be conveyed into a freezer. Thawed fruit at this stage can create a serious quality problem. The third method requires the actual cooking of the fruit. As discussed, the cooking of the fruit decreases the quality of the pie by creating a flat top crust. The final presentation and appearance of the frozen fruit filled pie is an important feature of a quality product.

While the above described methods of manufacturing pies can generate quality pies, none of the methods provide a teaching of how to manufacture a quality pie that has all of the fruit and other ingredients evenly suspended throughout the pie filling. Therefore, there exists a need to address one or more of the above identified disadvantages of the current technology.

### SUMMARY

In one aspect the Frozen Fruit Filled Pie Production is a method for manufacturing a frozen fruit filled pie. First, ingredients are mixed together to create pie dough. Then the pie dough is formed into a pie shell. Next, IQF fruit is added to the pie shell. After adding the fruit a suspension is deposited over the IQF fruit in the pie shell. A top sheet of pie dough is applied over the suspension, IQF fruit and pie shell and sealed shut. The pie is then frozen in a freezer, packaged for shipment and stored in a frozen storage.

In another aspect, the Frozen Fruit Filled Pie Production is a frozen fruit filled pie manufactured by a process that begins with mixing ingredients to create pie dough. Next, the pie dough is formed into a pie shell and IQF fruit is added to the pie shell. The IQF fruit that is added to the pie shell remains frozen throughout the manufacturing process. Then a suspension is deposited over the IQF fruit in the pie shell. The suspension is used to create a stable suspension of the ingredients and IQF fruit. Next, a top sheet of pie dough is applied and sealed over the suspension, IQF fruit and pie shell. Finally, the frozen fruit filled pie is frozen, packaged and stored for distribution.

In another aspect, the Frozen Fruit Filled Pie Production is a suspension for creating a stable suspension of dry materials in a pie with a wide range of specific gravities. The suspension is manufactured with the following ingredients: a range of about 38% to about 88% liquid sweetener, or in other embodiments, a range of about 45% to about 80% liquid sweetener, or in other embodiments, a range of about 50% to about 75% liquid sweetener, or in other embodiments, a range of about 55% to about 70% liquid sweetener, or in other embodiments, a range of about 60% to about 70% liquid sweetener; a range of about 5% to about 55% dry sweetener, or in other embodiments, a range of about 15% to about 45% dry sweetener, or in other embodiments, a range of about 25% to about 35% dry sweetener; a range of about 4% to about 15% food starch, or in other embodiments, a range of about 6% to about 12% food starch, or in other embodiments, a range of about 8% to about 10% food starch; a range of about 0.01% to about 5.0% food gum, or in other embodiments, a range of about 0.03% to about 4% food gum, or in other embodiments, a range of about 0.04% to about 3% food gum; a range of about 0% to about 8% oily material, or in other embodiments, a range of about 2% to about 6% oily material, or in other embodiments, a range of about 3% to about 5% oily material; a range of about 0% to about 4% flavorants, or in other embodiments, a range of about 1% to about 3% flavorants; and, a range of about 0% to about 3% minor ingredients, or in other embodiments, a range of about 0.5% to about 2.5% minor ingredients, or in other embodiments, a range of about 1% to about 2% minor ingredients.

The suspension exhibits a rapid reduction of viscosity when initially heated from frozen to about 120 degrees Fahrenheit in the bake cycle, and a rapid increase of viscosity when exposed to temperatures above 120 degrees Fahrenheit. The liquid sweetener may be, for example, high fructose corn syrup, corn syrup, invert syrup, or saturated saccharide solution. The food gum may be, for example, alginate, carrageenan, locust bean gum, guar gum, xanthan gum, or gellan gum. The minor ingredients may be, for example, processing aids, preservatives, or colors, etc.

In another aspect the Frozen Fruit Filled Pie Production is a method for suspending frozen fruit filled pie ingredients of various specific gravities in a frozen fruit filled pie. The method is performed by mixing a first set of ingredients to form a suspension. The suspension is comprised of liquid, dry sweeteners, stabilizers, flavors and minor ingredients. The a second set of ingredients is mixed to create pie dough, which is then formed into a pie shell. Next, IQF fruit is added to the pie shell and the suspension is deposited over the IQF fruit in the pie shell. The suspension is used to suspend the IQF fruit and other ingredients in a uniform distribution upon baking of the pie. A top sheet of pie dough is then applied over the suspension, IQF fruit and the pie shell. The top sheet of pie dough is sealed to the pie shell, thereby sealing the frozen fruit filled pie. Finally, the pie is frozen.

The preferred embodiments are described below in the Figures and Detailed Description. Unless specifically noted, it is applicants' intention that the words and phrases in the specification and claims be given the ordinary and accustomed meaning to those of ordinary skill in the applicable art(s). If the applicants intend any other meaning, they will specifically state they are applying a special meaning to a word or phrase.

### DESCRIPTION OF THE DRAWINGS

The detailed description will refer to the following drawings, wherein like numerals refer to like elements, and wherein:

FIG. 1 shows a frozen fruit filled pie and the ingredients that are used to manufacture the pie;

FIG. 2 is cross-sectional view of the frozen fruit filled pie showing the suspension of the IQF fruit and pie ingredients;

FIG. 3 shows a mixing vessel used to mix the suspension used in the frozen fruit filled pie;

FIG. 4 is a flow chart diagram illustrating the steps for the method of manufacturing a frozen fruit filled pie; and

FIG. 5 is a flow chart diagram illustrating the steps for the method of manufacturing the suspension for the frozen fruit filled pie.

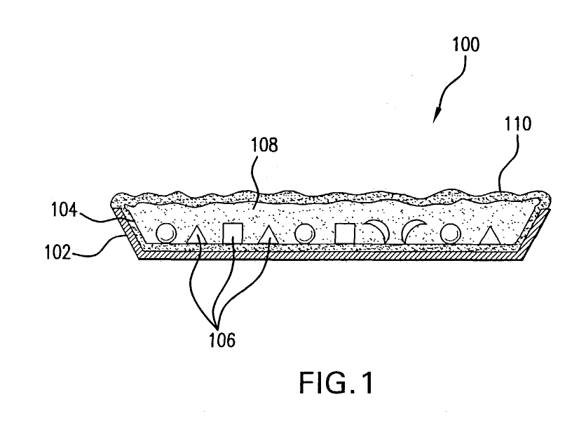

### DETAILED DESCRIPTION

Uniform distribution of ingredients in the pie filling is advantageous to finished product quality. This is because consumers want each slice to have the same appearance and flavor profile. The fluid system of Frozen Fruit Filled Pie Production provides a medium that moves between the fruit pieces during the bake process. This fluid medium distributes the setting agents and flavors uniformly between the fruit. In order to achieve this uniform distribution and desired appearance, the Frozen Fruit Filled Pie Production utilizes a fluid suspension to overcome the shortcomings of the prior art, as detailed above. During manufacture the suspension is deposited over the IQF fruit prior to the sealing of the pie. Upon baking, the fluid suspension creates a stable suspension of the pie ingredients that all have a wide range of specific gravity.

With reference now to the FIG. I of the drawings, there is illustrated therein a frozen fruit filled pie depicting the various ingredients, generally designated by the reference numeral 100. The frozen fruit filled pie is manufactured in a pie pan 102. During the manufacturing process, pie dough is created. A portion of the created pie dough is then molded into a pie shell 104 and placed on top of, the pie pan 108. Next, pieces of individually quickly frozen (“IQF”) fruit 106 are added to the pie shell 104. It is important to note that during the manufacturing process of the frozen fruit filled pie, the IQF fruit remains frozen. Highest quality pies are made with Grade A IQF fruit where the fruit has remained frozen when put into the shell and is not thawed until the end user bakes the pie. This aspect of the frozen fruit filled pie is important because it avoids the shortcomings associated with systems and manufacturing processes where the fruit would either thaw or be cooked prior to the freezing of the pie.

The suspension 108 is deposited over the IQF fruit 106 in the pie shell 104. Uniform distribution of ingredients in pie filling is desired by consumers in finished product quality. This is because each slice should have the same appearance and flavor profile. The suspension 108 provides a medium that moves between the fruit pieces during the bake process. Thus, the suspension 108 distributes the setting agents and flavors uniformly where space between the fruit allows. A top sheet 110 of the pie dough is created and applied over the suspension 108, IQF fruit 106, and pie shell 104. The top sheet 110 is then sealed to the pie shell 104. The manufacture of the frozen fruit filled pie may be performed mechanically, or in alternative embodiments the manufacture of the pie may be performed manually.

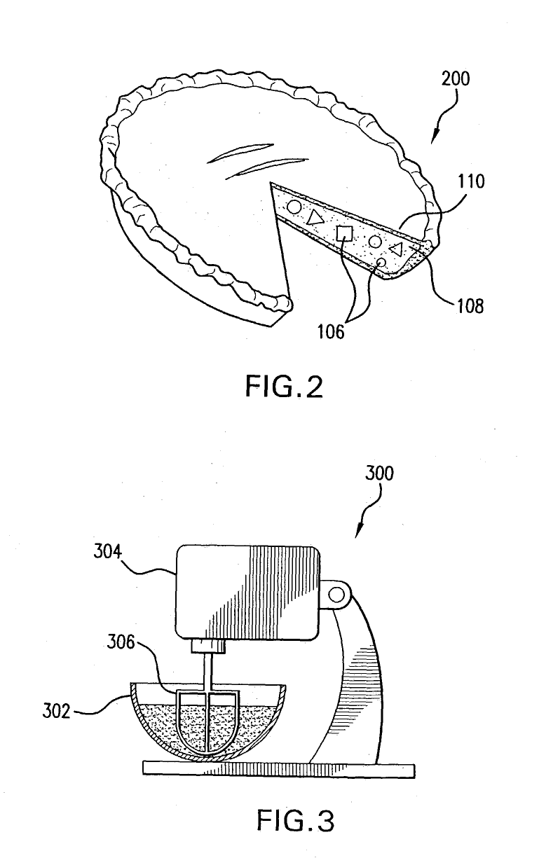

With reference now to the FIG. 2 of the drawings, there is illustrated therein a cross sectional view of a frozen fruit filled pie depicting the suspension of the various ingredients, generally designated by the reference numeral 200. As illustrated in FIG. 2, a slice of the pie has been removed from a frozen fruit filled pie that has already been baked. The cross-sectional view of the pie shows that the IQF fruit 106 are suspended in the pie filling and evenly distributed throughout the inside of the pie. The suspension and even distribution of the fruit is made possible by unique characteristics of the suspension 108. The suspension 108 exhibits rapid reduction of viscosity when initially heated from frozen to about 120 degrees Fahrenheit. The rapid reduction of viscosity aids with the even distribution of the suspension within the pie. In addition, the suspension 108 exhibits a rapid increase in viscosity at temperatures above 120 F. The rapid increase of viscosity aids with the set of the pie and ability to serve slices properly.

The suspension also aids with the distribution of the starch and gums. The distribution of starch and gums by a fluid medium within the fruit prior to baking creates a unique effect upon the finished pie filling. The pie filling will have a glossy smooth appearance that the prior art methods fail to provide. Other benefits include moisture management in the finished baked pie. This prevents, among other problems, fruit juice from soaking the piecrust. During baking, juice is liberated from the fruit, which can cause starch and food gums to become lumpy and unappetizing. The use of the suspension aids in this regard as it produces a frozen fruit filled pie that is resistant to lumping when exposed to moisture.

With reference now to the FIG. 3 of the drawings, there is illustrated therein a mixer used to mix the suspension 108 used in the frozen fruit filled pie, generally designated by the reference numeral 300. The formula for the suspension 108 may include:

a range of about 38% to about 88% liquid sweetener, or in other embodiments, a range of about 45% to about 80% liquid sweetener, or in other embodiments, a range of about 50% to about 75% liquid sweetener, or in other embodiments, a range of about 55% to about 70% liquid sweetener, or in other embodiments, a range of about 60% to about 70% liquid sweetener;

a range of about 5% to about 55% dry sweetener, or in other embodiments, a range of about 15% to about 45% dry sweetener, or in other embodiments, a range of about 25% to about 35% dry sweetener;

a range of about 4% to about 15% food starch, or in other embodiments, a range of about 6% to about 12% food starch, or in other embodiments, a range of about 8% to about 10% food starch;

a range of about 0.01% to about 5.0% food gum, or in other embodiments, a range of about 0.03% to about 4% food gum, or in other embodiments, a range of about 0.04% to about 3% food gum;

a range of about 0% to about 8% oily material, or in other embodiments, a range of about 2% to about 6% oily material, or in other embodiments, a range of about 3% to about 5% oily material;

a range of about 0% to about 4% flavorants, or in other embodiments, a range of about 1% to about 3% flavorants; and,

a range of about 0% to about 3% minor ingredients, or in other embodiments, a range of about 0.5% to about 2.5% minor ingredients, or in other embodiments, a range of about 1% to about 2% minor ingredients.

The liquid sweetener may be a high fructose corn syrup, corn syrup, invert syrup, or other saturated saccharide solutions. The use of a saturated saccharide solution provides the suspension with its unique characteristics. The food gum may be alginate, carrageenan, locust beangum, guar gum, xanthan gum, gellan gum, or other known gums. The oily material may be butter or margarine, or other similar material. The flavorants may be salt, spice, acids or flavors. The 0-3% “minor ingredients” may include processing aids, preservatives, or colors, etc. The process for making the suspension begins by adding liquid sweetener into a mixing vessel 302. The mixing vessel may be equipped with a high shear mixing element 304 and a stirring element 306. In one embodiment a Breddo Liquefier mixer is used. The Breddo Liquefier has a high shear element and a stirring element to adequately mix the ingredients to achieve the desired composition of the suspension. The dry ingredients are then blended and added to the liquid sweetener while the mixing 304 and stirring elements 306 are activated. The mixing is continued until the dry ingredients are uniformly distributed into the liquid sweetener.

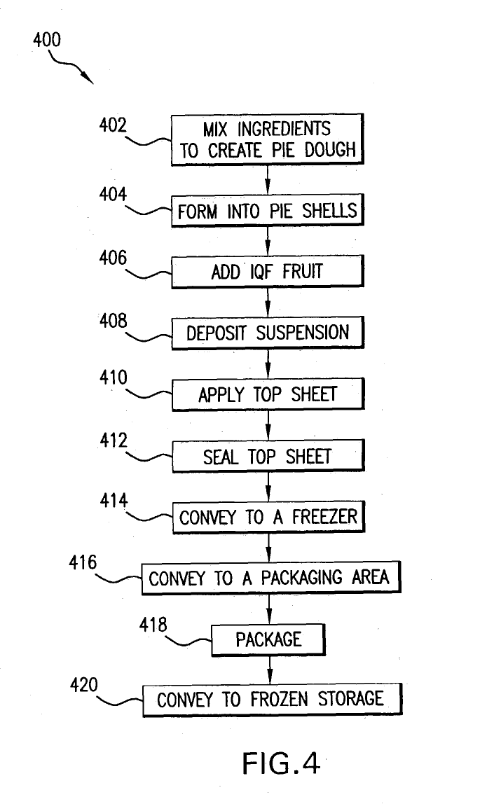

With reference now to the FIG. 4 of the drawings, there is illustrated therein a flow chart diagram illustrating the steps for the, method of manufacturing frozen filled pies using a suspension, generally designated by the reference numeral 400. The method 400 begins by mixing the necessary ingredients to create pie dough 402. Next, a portion of the pie dough is formed into pie shells 404. Then, the IQF fruit is added to the pie shell 406. As noted above, the present method for manufacturing frozen fruit filled pies allows the IQF fruit to remain frozen throughout the manufacturing process.

Next, the suspension is deposited over the IQF fruit in the pie shell 408, and a top sheet of pie dough is added to the top of the suspension 410. The top sheet is then sealed to the pie shell 412. The sealing of the top sheet seals the frozen pie shut. Next, the pie is then conveyed to a freezer for freezing 414. After the pie is frozen, it is then conveyed to a packaging area 416 and packaged 418. Finally, the frozen pie is conveyed to a frozen storage 420.

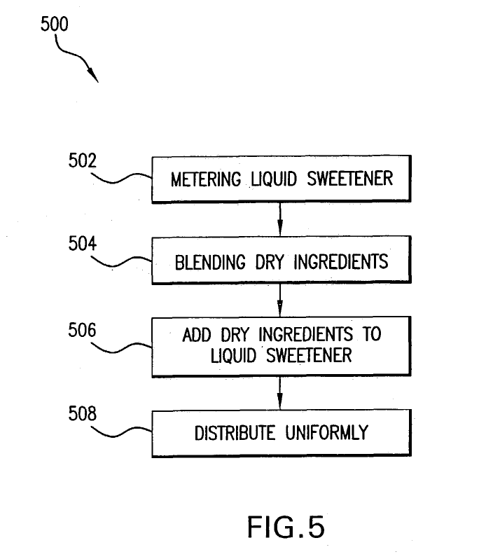

With reference now to the FIG. 5 of the drawings, there is illustrated therein a flow chart diagram illustrating the steps for the method of manufacturing the suspension for the frozen fruit filled pies, generally designated by the reference numeral 500. The method begins by metering liquid sweetener into a mixing vessel 502. As discussed above, the mixing vessel may be equipped with a high shear mixing element and a stirring element. Next, the dry ingredients are blended together 504. Then the dry ingredients are added to the liquid sweetener while the mixing and stirring elements are activated 506. The execution of the mixing and stirring elements is then continued until the dry ingredients are uniformly distributed into the liquid sweetener 508.

Use of a fluid to create a stable suspension of dry materials with a wide range in specific gravity is a remarkable advancement over the prior art. The manufacture of frozen fruit filled pies with a suspension accomplishes a combination of properties including, ease of manufacture and reasonable ingredient costs. For instance, liquid sweeteners are generally less expensive than dry sweeteners. And, when compared to prior art fruit pies, the amount of food starch that is used with the manufacture of frozen fruit filled pies with a suspension is reduced. Also, equipment that is used to rapidly meter and deposit fluids is relatively low in cost and simple to maintain. In addition, the suspension and methods disclosed herein provide for a much more sanitary process that requires fewer resources during cleanup.

The inventions set forth above are subject to many modifications and changes without departing from the spirit, scope or essential characteristics thereof. Thus the embodiments explained above should be considered in all respect as being illustrative rather than restrictive of the scope of the inventions as defined in the appended claims.

In the claims:

1. A method for manufacturing a frozen fruit filled pie, said method comprising the steps of:
mixing ingredients to create pie dough;
forming a portion of said pie dough into a pie shell;
adding individually quickly frozen (“IQF”) fruit into said pie shell;
depositing a suspension over said IQF fruit in said pie shell; and
applying a top sheet of pie dough over said suspension, IQF fruit and pie shell.

2. The method according to claim 1, further comprising the step of:
sealing said top sheet of pie dough to the bottom of said pie shell, thereby sealing said frozen fruit filled pie.

3. The method according to claim 2, wherein said method further includes the steps of:
conveying said frozen fruit filled pie through a freezer; and
conveying said frozen fruit filled pie to a packaging area and packaging said frozen fruit filled pie.

4. The method according to claim 1, wherein said suspension is comprised of liquid, dry sweeteners, stabilizers, flavors and minor ingredients.

5. The method according to claim 4, wherein the formula for said suspension is:
a range of about 38% to about 88% liquid sweetener;
a range of about 5% to about 55% dry sweetener;
a range of about 4% to about 15% food starch; and
a range of about 0.01 % to about 5.0% food gum.

6. The method according to claim 5, wherein the formula for said suspension further includes:
a range of about 0% to about 8% oily material;
a range of about 0% to about 4% flavorants; and
a range of about 0% to about 3% minor ingredients chosen from the group consisting of: processing aids, preservatives, and colors, etc.

7. The method according to claim 4, wherein said liquid sweetener is chosen from the group consisting of: high fructose corn syrup, corn syrup, invert syrup, and saturated saccharide solution.

8. The method according to claim 4, wherein said food gum is chosen from the group consisting of: alginate, carrageenan, locust bean gum, guar gum, xanthan gum, and gellan gum.

9. The method according to claim 9, wherein the manufacturing of said suspension, includes the steps of:
metering the liquid sweetener into a mixing vessel;
blending the dry ingredients; and
adding said dry ingredients to said liquid sweetener while mixing.

10. The method according to claim 9, further including the step of:
continuing mixing until said dry ingredients are uniformly distributed into said liquid sweetener.

11. The method according to claim 1, wherein said IQF fruit remains frozen throughout the manufacturing process and is not thawed until the end user bakes the frozen fruit filled pie.

12. The method according to claim 1, wherein the distribution of said starch and gums within the IQF fruit prior to baking creates a glossy smooth appearance upon the finished frozen fruit filled pie filling.

13. The method according to claim 1, wherein said suspension exhibits rapid reduction of viscosity when exposed to heat.

14. The method according to claim 1, wherein said suspension exhibits rapid increase of viscosity when exposed to temperatures above 120 degrees Fahrenheit.

15. The method according to claim 1 wherein the use of said suspension creates a stable suspension of the ingredients and IQF fruit.

16. A frozen fruit filled pie, said frozen fruit filled pie manufactured by the process of:
mixing ingredients to create pie dough;
forming a portion of said pie dough into a pie shell;
adding individually quickly frozen (“IQF”) fruit into said pie shell, wherein said IQF fruit remains frozen throughout the manufacturing process;
depositing a suspension over said IQF fruit in said pie shell, wherein said suspension creates a stable suspension of the ingredients and IQF fruit; and
applying a top sheet of pie dough over said suspension, IQF fruit and pie shell.

17. The frozen fruit filled pie according to claim 16, wherein said process further includes sealing said top sheet of pie dough to the bottom of said pie shell, thereby sealing said frozen fruit filled pie.

18. The frozen fruit filled pie according to claim 17, wherein said process further includes:
conveying said frozen fruit filled pie through a freezer; and
conveying said frozen fruit filled pie to a packaging area and packaging said frozen fruit filled pie.

19. The frozen fruit filled pie according to claim 16, wherein said suspension is comprised of liquid, dry sweeteners, stabilizers, flavors and minor ingredients.

20. The frozen fruit filled pie according to claim 19, wherein the formula for said suspension is:
a range of about 38% to about 88% liquid sweetener;
a range of about 5% to about 55% dry sweetener;
a range of about 4% to about 15% food starch; and
a range of about 0.01% to about 5% food gum.

21. The frozen fruit filled pie according to claim 20, wherein the formula for said suspension further includes:
a range of about 0% to about 8% oily material;
a range of about 0% to about 4% flavorants; and
a range of about 0% to about 3% minor ingredients chosen from the group consisting of: processing aids, preservatives, and colors, etc.

22. The frozen fruit filled pie according to claim 20, wherein said liquid sweetener is chosen from the group consisting of: high fructose corn syrup, corn syrup, invert syrup, and saturated saccharide solution.

23. The frozen fruit filled pie according to claim 20, wherein said food gum is chosen from the group consisting of: alginate, carrageenan, locust bean gum, guar gum, xanthan gum, and gellan gum.

24. The frozen fruit filled pie according to claim 21, wherein the manufacturing of said suspension, includes the steps of:
metering liquid sweetener into a mixing vessel;
blending the dry ingredients; and
adding said dry ingredients to said liquid sweetener while mixing.

25. The frozen fruit filled pie according to claim 24, wherein the manufacturing of said suspension, includes the step of:
continuing mixing until said dry ingredients are uniformly distributed into said liquid sweetener.

26. The frozen fruit filled pie according to claim 16, wherein the distribution of said starch and gums within the IQF fruit prior to baking creates a glossy smooth appearance upon the finished frozen fruit filled pie filling.

27. The frozen fruit filled pie according to claim 16, wherein said suspension exhibits rapid reduction of viscosity when exposed to heat.

28. The frozen fruit filled pie according to claim 16, wherein said suspension exhibits rapid increase of viscosity When heated or exposed to temperatures below above degrees.

29. A suspension for creating a stable suspension of dry materials in a frozen fruit filled pie with a wide range of specific gravities, said suspension comprising:
a range of about 38% to about 88% liquid sweetener;
a range of about 5% to about 55% dry sweetener;
a range of about 4% to about 15% food starch; and
a range of about 0.01 % to about 5.0% food gum.

30. The suspension according to claim 29, further comprising:
a range of about 0% to about 8% oily material;
a range of about 0% to about 4% flavorants; and
a range of about 0% to about 3% minor ingredients chosen from the group consisting of: processing aids, preservatives, and colors, etc.

31. The suspension according to claim 29, wherein said liquid sweetener is chosen from the group consisting of: high fructose corn syrup, corn syrup, invert syrup, and saturated saccharide solution.

32. The suspension according to claim 29, wherein said food gum is chosen from the group consisting of: alginate, carrageenan, locust bean gum, guar gum, xanthan gum, and gellan gum.

33. The suspension according to claim 29, wherein said suspension exhibits rapid reduction of viscosity when exposed to heat.

34. The suspension according to claim 29, wherein said suspension exhibits rapid increase of viscosity when exposed to temperatures above 120 degrees Fahrenheit.

35. A method for suspending frozen fruit filled pie ingredients of various specific gravities in a frozen fruit filled pie, said method comprising the steps of:
mixing a first set of ingredients to form a suspension, said suspension comprised of liquid, dry sweeteners, stabilizers, flavors and minor ingredients;
mixing a second set of ingredients to create pie dough;
forming a portion of said pie dough into a pie shell;
adding individually quickly frozen (“IQF”) fruit into said pie shell;
adding said suspension over said IQF fruit in said pie shell, said suspension used to suspend said IQF fruit in a uniform distribution upon baking of said frozen fruit filled pie; and
applying a top sheet of pie dough over said suspension, IQF fruit and pie shell.

36. The method according to claim 35, further comprising the steps of:
sealing said top sheet of pie dough to the bottom of said pie shell, thereby sealing said frozen fruit filled pie; and
freezing said frozen fruit filled pie.

37. The method according to claim 35, wherein the manufacturing of said suspension, includes the steps of:
metering liquid sweetener into a mixing vessel;
blending the dry ingredients; and
adding said dry ingredients to said liquid sweetener while mixing.

38. The method according to claim 37, wherein the manufacturing of said suspension, further includes the steps of:
continuing execution of said mixing and stirring elements until said dry ingredients are uniformly distributed into said liquid sweetener.

39. The method according to claim 35, wherein the formula for said suspension is:
a range of about 38% to about 88% liquid sweetener;
a range of about 5% to about 55% dry sweetener;
a range of about 4% to about 15% food starch; and
a range of about 0.01 % to about 5.0% food gum.

40. The method according to claim 39, wherein the formula for said suspension further includes:
a range of about 0% to about 8% oily material;
a range of about 0% to about 4% flavorants; and
a range of about 0% to about 3% minor ingredients chosen from the group consisting of: processing aids, preservatives, and colors, etc.

41. The method according to claim 35, wherein said IQF fruit remains frozen throughout the manufacturing process.

42. The method according to claim 35, wherein the distribution of said starch and gums within the IQF fruit prior to baking creates a glossy smooth appearance upon the finished frozen fruit filled pie filling.

43. The method according to claim 35, wherein said suspension exhibits rapid reduction of viscosity when exposed to heat.

44. The method according to claim 35, wherein said suspension exhibits rapid increase of viscosity when exposed to temperature increases above 120 Fahrenheit.
